(19) United States
(12) Patent Application Publication
(10) Pub. No.: US 2026/0168862 A1
(43) Pub. Date: Jun. 18, 2026

(54) METHOD AND APPRARTUS FOR DETECTING ORBITAL ANGULAR MOMENTUM OF LIGHT

(71) Applicants: KOREA UNIVERSITY RESEARCH AND BUSINESS FOUNDATION, Seoul (KR); INSTITUTE FOR BASIC SCIENCE, Daejeon (KR)

(72) Inventors: Minhaeng CHO, Seoul (KR); Ju-Young KIM, Seoul (KR)

(21) Appl. No.: 19/417,519

(22) Filed: Dec. 12, 2025

(30) Foreign Application Priority Data
Dec. 17, 2024 (KR) 10-2024-0188663
Nov. 25, 2025 (KR) 10-2025-0180210

(51) Int. Cl. G01J 7/00

(52) U.S. Cl. CPC G01J 7/00

(57) ABSTRACT

The present disclosure relates to a method and an apparatus for detecting an orbital angular momentum of light. The method for detecting an orbital angular momentum of light according to an embodiment of the present disclosure includes step S100 of, when one of two input laser beams is a vortex beam to be detected, obtaining an output signal for each topological charge (TC) of an opposing beam, which is the other one of two input laser beams, by using a nonlinear optical detection technique while changing the topological charge of the opposing beam; and step S200 of measuring an orbital angular momentum (OAM) of the vortex beam to be detected, based on the topological charge of the opposing beam having a highest signal value among the output signals.

### BACKGROUND

### 1. Technical Field

The present disclosure relates to a method and an apparatus for detecting an orbital angular momentum of light, and more particularly, to a technology for detecting an orbital angular momentum of a vortex beam having a helical wavefront on the basis of a nonlinear optical detection technique.

### 2. Related Art

Existing optical communication systems transfer information by using properties of light such as amplitude, phase, frequency, and polarization. However, such methods have a limited information capacity due to physical and technical limitations. In particular, a bandwidth of a communication channel, a signal-to-noise ratio, and the like may limit information transfer capabilities. In order to solve such problems and increase optical data transmission capacity, an orbital angular momentum (OAM) of light can be used. The OAM is a property of a vortex beam having a helical wavefront, and the optical communication systems can provide a new dimension capable of independently transmitting more data through the OAM. The vortex beam has a helical wavefront, and its phase is proportional to exp(−ilφ), wherein l indicates a topological charge (TC) expressed as an integer.

In order to measure the OAM of the vortex beam, the related art mainly uses a technique using diffraction and interference phenomena, and the like. However, the OAM measurement techniques in the related art have clear limitations such as complex calculations, reliance on simulations, and the need to restore distorted light during transmission. Ultimately, in optical communication systems using the OAM, which have been recently highlighted, accurately detecting the OAM by a receiver remains a significant technical challenge.

Therefore, there is a pressing need for solutions to the problems of the OAM detection technology in the related art.

### SUMMARY

Various embodiments are directed to providing a method and an apparatus for detecting an orbital angular momentum of a vortex beam on the basis of a nonlinear optical detection technique.

A method for detecting an orbital angular momentum of light according to an embodiment of the present disclosure includes: a step of, when one of two input laser beams is a vortex beam to be detected, obtaining an output signal for each topological charge (TC) of an opposing beam, which is the other one of the two input laser beams, by using a nonlinear optical detection technique while changing the topological charge of the opposing beam; and a step of measuring an orbital angular momentum (OAM) of the vortex beam to be detected, based on the topological charge of the opposing beam having a highest signal value among the output signals.

In the method for detecting an orbital angular momentum of light, the nonlinear optical detection technique may be any one selected from the group consisting of stimulated Raman scattering (SRS) spectroscopy, coherent anti-Stokes Raman scattering (CARS) spectroscopy, and sum-frequency generation (SFG) spectroscopy.

In the method for detecting an orbital angular momentum of light, the topological charge of the opposing beam may be changed by vortex beam generation means disposed on an opposing beam path, the opposing beam path not being shared with the vortex beam to be detected, only the opposing beam moving along the opposing beam path.

In the method for detecting an orbital angular momentum of light, the vortex beam generation means may include at least one selected from the group consisting of a vortex plate (or spiral phase plate), a spatial light modulator, a diffractive optical element, a metasurface, a photonic integrated circuit, a holographic grating, and a Q-plate.

In the method for detecting an orbital angular momentum of light, a topological charge of the vortex beam to be detected may correspond to the topological charge of the opposing beam having the highest signal value among the output signals.

An apparatus for detecting an orbital angular momentum of light according to an embodiment of the present disclosure is an apparatus for detecting an orbital angular momentum of light using a stimulated Raman scattering (SRS) spectroscopy device and includes: vortex beam generating means that, when one of a pump beam and a Stokes beam is a vortex beam to be detected and the other is an opposing beam, is disposed on an opposing beam path, the opposing beam path not being shared with the vortex beam to be detected, only the opposing beam moving along the opposing beam path, and changes a topological charge of the opposing beam; a signal output unit that generates an output signal for each topological charge of the opposing beam; and an OAM measurement unit that measures an orbital angular momentum (OAM) of the vortex beam to be detected, based on the output signal generated by the signal output unit.

The apparatus for detecting an orbital angular momentum of light may further include: an electro-optical modulator disposed on a first optical path along which the Stokes beam moves and configured to modulate a frequency of the Stokes beam; and an optical incident unit configured to allow the Stokes beam moving along the first optical path and the pump beam moving along a second optical path to be simultaneously incident onto a Raman-active sample, wherein the vortex beam generating means may be disposed on the first optical path or the second optical path.

In the apparatus for detecting an orbital angular momentum of light, the vortex beam generation means may include at least one selected from the group consisting of a vortex plate (or spiral phase plate), a spatial light modulator, a diffractive optical element, a metasurface, a photonic integrated circuit, a holographic grating, and a Q-plate.

In the apparatus for detecting an orbital angular momentum of light, the OAM measuring unit may treat the topological charge of the opposing beam having a highest signal value among the output signals as a topological charge of the vortex beam to be detected.

The features and advantages of the present disclosure will become more apparent from the following detailed description based on the accompanying drawings.

Prior to describing the present disclosure, the terms or words used in this specification and claims should not be construed as typical or dictionary definitions, but should be construed as meanings and concepts that coincide with the technical idea of the present disclosure, on the basis of a principle in which the inventor can appropriately define concepts of terms in order to explain his/her invention in a best way.

Since the method according to the present disclosure is an all-optical method in which all processes are optically performed, no additional materials are required to modulate the amplitude or phase of light during measurement.

In addition, orbital angular momentum information included in a vortex beam can be stably measured in a non-destructive manner in which photons are not annihilated by a photodetector and are preserved.

Moreover, in stimulated Raman scattering (SRS), when angular momentum information is transferred to a Stokes beam and a pump beam is used as a reference beam, the intensity of optical communication light including angular momentum information actually increases, thereby amplifying the intensity of a vortex beam carrying the optical information.

### BRIEF DESCRIPTION OF THE DRAWINGS

FIG. 1 is a flowchart of a method for detecting an orbital angular momentum of light according to an embodiment of the present disclosure.

FIG. 2 is a diagram for explaining an orbital angular momentum of a vortex beam.

FIG. 3 is a diagram for explaining the principle of the method for detecting an orbital angular momentum of light according to an embodiment of the present disclosure.

FIG. 4 is a configuration diagram of an apparatus for detecting an orbital angular momentum of light according to an embodiment of the present disclosure.

FIG. 5 is a configuration diagram of an apparatus for detecting an orbital angular momentum of light according to another embodiment of the present disclosure.

FIG. 6A is a diagram illustrating an SRS process of a Gaussian (LG₀₀) pump beam (1ₚ=0) and a doughnut-shaped (LG₀₁) Stokes beam (1_{c}≠0) according to an experimental example, and FIG. 6B is a schematic diagram schematically illustrating an SRS device (setup) according to the experimental example.

FIG. 7A illustrates the result obtained by numerically calculating lateral intensity distributions of a pump beam (left column) and a vortex beam (right column) transmitted at z=L (=41.6 μm), and FIG. 7B illustrates the calculation result of the laterally integrated intensity Iₚ (z=L) of the pump beam for the topological charge 1_{c}(=0 to 10) of the vortex beam and

$$( {I}_{p}^{0} - {I}_{p} ) / {I}_{p}^{0}$$

versus 1_{c}.

FIG. 8A illustrates the SRL of a pump beam for a topological charge 1ₚ of the pump beam when the topological charge I_{c} of the vortex beam is 0, 2, 4, 6, and 8 and the result

$$( {I}_{p}^{0} - {I}_{p} ) / {I}_{p}^{0}$$

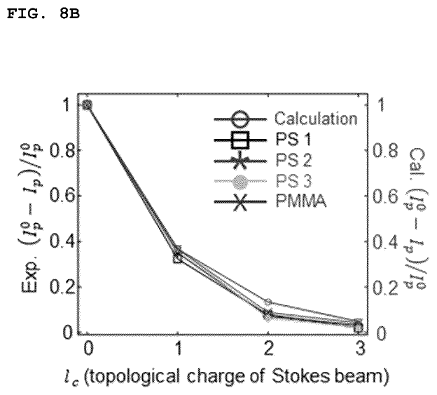

versus the topological charge 1ₚ, and FIG. 8B is a graph comparing the numerically calculated value

$$( {I}_{p}^{0} - {I}_{p} ) / {I}_{p}^{0}$$

(red) with an experimentally derived value.

### DETAILED DESCRIPTION

The terminology used herein is for the purpose of describing embodiments only and is not intended to limit the present disclosure. As used herein, the singular forms “a”, “an” and “the” are intended to include the plural forms as well, unless the context clearly indicates otherwise. The terms “comprises” and/or “comprising” of stated component, when used herein, do not exclude the presence or addition of one or more other components. Throughout the specification, like reference numerals represent the same components, and the term “and/or” includes each of mentioned components and one or more combinations thereof. Although terms “first” and “second” are used to describe various components, the components are not limited by the terms. The terms are used only to distinguish one element from another element. Therefore, a first component described below may be a second component within the technical idea of the present disclosure.

Throughout the specification, when a certain part is referred to as “including” a certain component, it means that the part may not exclude other components but further include other components, unless otherwise stated. Furthermore, a term such as “ . . . unit“and” . . . module” described in the specification means a unit for processing at least one function or operation, and this may be implemented with hardware, software, or a combination of the hardware and the software.

Hereinafter, preferred embodiments of the present disclosure are described in detail with reference to the accompanying drawings.

The terminology used herein is for the purpose of describing embodiments only and is not intended to limit the present disclosure. As used herein, the singular forms “a”, “an” and “the” are intended to include the plural forms as well, unless the context clearly indicates otherwise. The terms “comprises” and/or “comprising” of stated component, when used herein, do not exclude the presence or addition of one or more other components. Throughout the specification, like reference numerals represent the same components, and the term “and/or” includes each of mentioned components and one or more combinations thereof. Although terms “first” and “second” are used to describe various components, the components are not limited by the terms. The terms are used only to distinguish one element from another element. Therefore, a first component described below may be a second component within the technical idea of the present disclosure.

Throughout the specification, when a certain part is referred to as “including” a certain component, it means that the part may not exclude other components but further include other components, unless otherwise stated. Furthermore, a term such as “ . . . unit“and” . . . means” described in the specification means a unit for processing at least one function or operation, and this may be implemented with an optical element, hardware, software, or a combination of the hardware and the software.

Hereinafter, preferred embodiments of the present disclosure are described in detail with reference to the accompanying drawings.

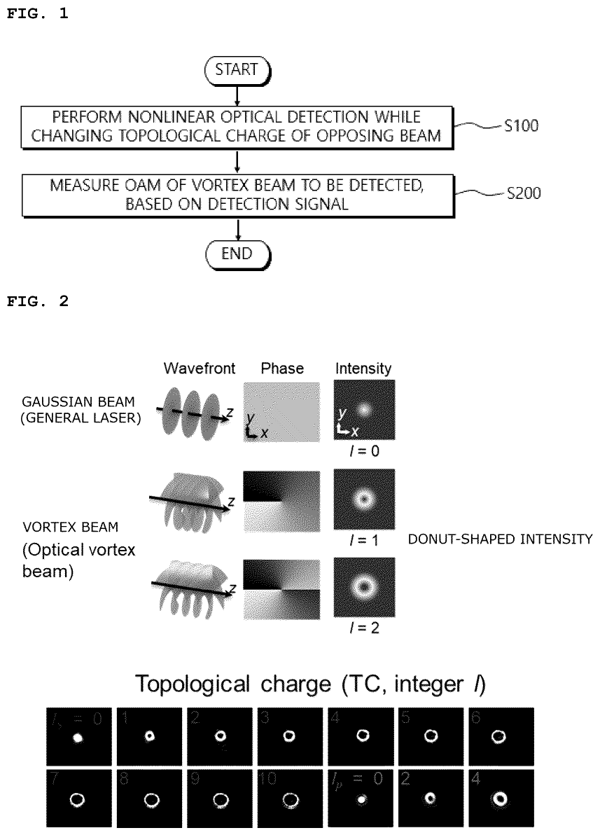

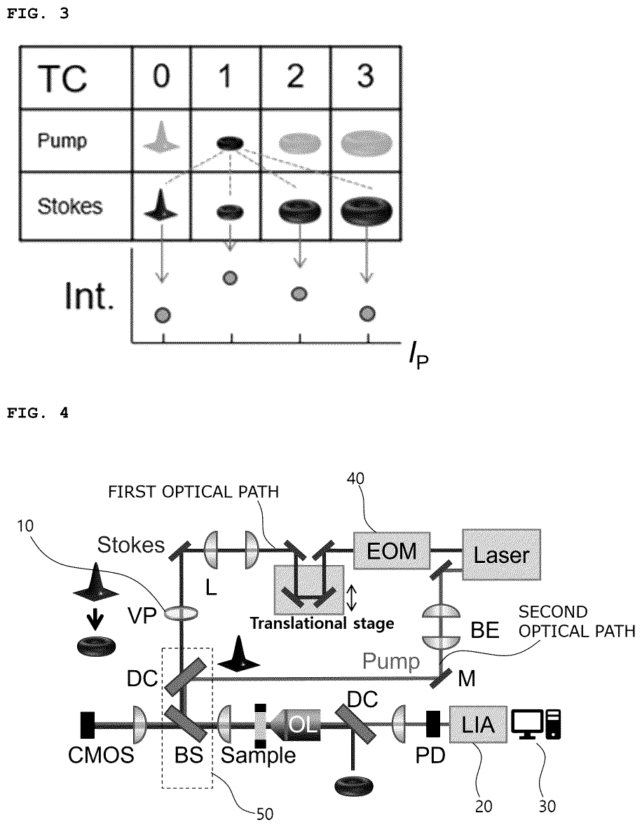

FIG. 1 is a flowchart of a method for detecting an orbital angular momentum of light according to an embodiment of the present disclosure, FIG. 2 is a diagram for explaining an orbital angular momentum of a vortex beam, and FIG. 3 is a diagram for explaining the principle of the method for detecting an orbital angular momentum of light according to an embodiment of the present disclosure.

As illustrated in FIGS. 1 to 3, the method for detecting the orbital angular momentum of light according to an embodiment of the present disclosure includes step S100 of, when one of two input laser beams is a vortex beam to be detected, obtaining an output signal for each topological charge (TC) of an opposing beam, which is the other one of two input laser beams, by using a nonlinear optical detection technique while changing the topological charge of the opposing beam, and step S200 of measuring an orbital angular momentum (OAM) of the vortex beam to be detected, based on the topological charge of the opposing beam having the highest signal value among the output signals.

The present disclosure relates to a method and an apparatus for detecting the orbital angular momentum (OAM) of the vortex beam having a helical wavefront based on the nonlinear optical detection technique. Since most information communications used today use binary systems and even a huge amount of information is mostly composed of combinations of 0s and 1s, the information communications can store a lot of information. On the other hand, when information is transferred using the OAM of a vortex beam in optical communication, the amount and speed of information can be dramatically increased. However, in optical communication, the OAM information of light transmitted by a transmitter is stored in the topological charge of a vortex beam, and according to the related art, there are technical limitations that a receiver is not able to accurately detect the OAM. Therefore, the present disclosure was devised as a solution to overcome the problems of the related art.

Specifically, the method for detecting an orbital angular momentum of light according to an embodiment of the present disclosure includes a nonlinear optical detection step S100 and an OAM measurement step S200.

The nonlinear optical detection step S100 is a process of obtaining the output signal by using the nonlinear optical detection technique while changing the topological charge of the opposing beam. The output signal is obtained from the two input laser beams.

General laser beams have a Gaussian phase having a plane wave shape. However, when the phase is twisted into a vortex shape, angular momentum (OAM) is generated. The angular momentum can be expressed as a topological charge (TC), and the topological charge is determined by how many multiples of 2π the phase changes as light completes one rotation around a main axis. That is, when the phase changes by 2π during one rotation of light, the topological charge is 1, and when the phase changes by 4π, the topological charge is 2. Such a topological charge may increase in an integer multiple of infinity. When light rotates clockwise, the topological charge is positive (+), and when light rotates counterclockwise, the topological charge is negative (−). A vortex beam has a donut shape, and regardless of sign, as the absolute value of the topological charge increases, the size of the donut gradually increases (see FIG. 2).

One of the two input laser beams is a vortex beam to be detected, the orbital angular momentum (OAM) of which is to be measured, and the other is an opposing beam that generates an output signal together with the vortex beam to be detected when the nonlinear optical detection technique is performed.

The nonlinear optical detection technique may be any one selected from the group consisting of stimulated Raman scattering (SRS) spectroscopy, coherent anti-Stokes Raman scattering (CARS) spectroscopy, and sum-frequency generation (SFG) spectroscopy.

SRS is a technique that allows a high-energy pump beam and a relatively low-energy Stokes beam to be incident on a Raman-active sample so as to simultaneously and spatially overlap each other, thereby detecting the Stimulated Raman loss (SRL) of the pump beam or the Stimulated Raman gain (SRG) of the Stokes beam. Accordingly, when the SRS technique is utilized, one of the pump beam and the Stokes beam serves as a vortex beam to be detected and the other serves as an opposing beam, so that the SRL or SRG can be obtained as an output signal.

CARS is a nonlinear Raman spectroscopy technique that uses three light of a pump beam, a Stokes beam, and a probe beam to generate a strong and phase-matched anti-Stokes signal from a sample. Accordingly, when the CARS technique is utilized, one of the pump beam and the Stokes beam serves as a vortex beam to be detected and the other serves as an opposing beam, so that an anti-Stokes signal can be obtained as the output signal.

SFG is a nonlinear optical spectroscopy technique that simultaneously illuminates a sample surface with two laser beams, generates a new beam by adding frequencies of the two beams, and measures the intensity of an output beam. Accordingly, one of the two laser beams serves as a vortex beam to be detected and the other serves as an opposing beam, so that the intensity of the new beam as an output signal can be obtained.

Since the vortex beam to be detected has OAM properties and is a laser beam from which OAM is to be detected in the present disclosure, the topological charge of the vortex beam is fixed. On the other hand, the topological charge of the opposing beam is artificially changed, and an output signal is obtained using the nonlinear optical detection technique. The topological charge of the opposing beam can be changed by vortex beam generation means. The vortex beam generation means is disposed on an opposing beam path, which is not shared with the vortex beam to be detected and along which only the opposing beam moves. Accordingly, the topological charge of the vortex beam to be detected remains unchanged, while only the topological charge of the opposing beam is changed. The opposing beam is generated from a laser and initially moves along the opposing beam path as a Gaussian mode with the topological charge of 0, but the topological charge of the opposing beam is changed by the vortex beam generation means. Ultimately, the opposing beam is changed into a vortex beam with a predetermined topological charge (≠0) by the vortex beam generation means. The topological charge of the opposing beam is determined by the vortex beam generation means. The vortex beam generation means may include at least one selected from the group consisting of a vortex plate (or spiral phase plate), a spatial light modulator, a diffractive optical element, a metasurface, a photonic integrated circuit, a holographic grating, and a Q-plate. However, the vortex beam generation means is not necessarily limited thereto, and may be any means as long as it can change the topological charge of the opposing beam.

By fixing the topological charge of the vortex beam to be detected and changing the topological charge of the opposing beam in this way, a plurality of output signals can be obtained utilizing the nonlinear optical detection technique. The plurality of output signals have different signal values depending on the topological charge of the opposing beam. In the nonlinear optical detection, when two laser beams spatially overlap each other on a sample, an output signal is generated. The larger the area where the two laser beams spatially overlap each other, the higher the value of the output signal. The smaller the area where the two laser beams spatially overlap each other, the lower the value of the output signal. For example, referring to FIG. 3, when a pump beam is a vortex beam to be detected and a Stokes beam is an opposing beam, the topological charge of the Stokes beam is changed with the topological charge of the pump beam fixed, so that the highest signal value is output from the donut shape of the Stokes beam that best overlaps the donut shape of the pump beam. The donut shape of the Stokes beam is determined by the topological charge of the Stokes beam.

The OAM measurement step S200 is a process of measuring the orbital angular momentum (OAM) of the vortex beam to be detected, based on the output signal obtained for each topological charge of the opposing beam. In the nonlinear optical detection step S100, since the output signal is obtained through the nonlinear optical detection while changing the topological charge of the opposing beam with the topological charge of the vortex beam to be detected fixed.

On the other hand, the OAM measurement of the vortex beam to be detected is to detect the topological charge of the vortex beam to be detected. Since the topological charge of the vortex beam to be detected and the topological charge of the opposing beam determine the degree of overlap between the vortex beam to be detected and the opposing beam, when the overlap area is maximum, the value of the output signal is also maximum. When the topological charge of the vortex beam to be detected is identical to the topological charge of the opposing beam, the overlap area is maximum, and accordingly, the value of the output signal is also maximum. Accordingly, the OAM of the vortex beam to be detected can be measured by determining the topological charge of the vortex beam to be detected to correspond to the topological charge of the opposing beam with the highest signal value among the output signals, that is, to be identical to the topological charge of the opposing beam with the highest signal value among the output signals. Referring to FIG. 3, for example, in a case where the pump beam is the vortex beam to be detected and the OAM of the pump beam is to be measured, when an output signal is obtained using the nonlinear optical detection technique by changing the topological charge of the Stokes beam from 0 to 3, the signal value of the output signal varies depending on the topological charge of the Stokes beam. In such a case, since the magnitude of the signal value is maximum when the topological charge of the Stokes beam is “1”, the topological charge of the pump beam can be measured as “1”. When the output signal in the above example is obtained using the stimulated Raman scattering (SRS) spectroscopy technique, the output signal may be the stimulated Raman loss (SRL) of the pump beam and the SRL may be expressed as

$$( {I}_{p}^{0} - {I}_{p} ) / {I}_{p}^{0} .$$

### Here,

$${I}_{p}^{0}$$

is the integrated intensity of the pump beam when the topological charge of the Stokes beam is “0”, that is, when it does not exist as a vortex beam, and Iₚ is the integrated intensity of the pump beam when the topological charge of the Stokes beam is “≠0”, that is, when it exists as a vortex beam.

An apparatus for detecting an orbital angular momentum of light according to an embodiment of the present disclosure is described below.

Since the apparatus for detecting an orbital angular momentum of light according to an embodiment of the present disclosure relates to an apparatus capable of performing the aforementioned method for detecting an orbital angular momentum of light, contents overlapping the above-described contents are omitted or briefly described.

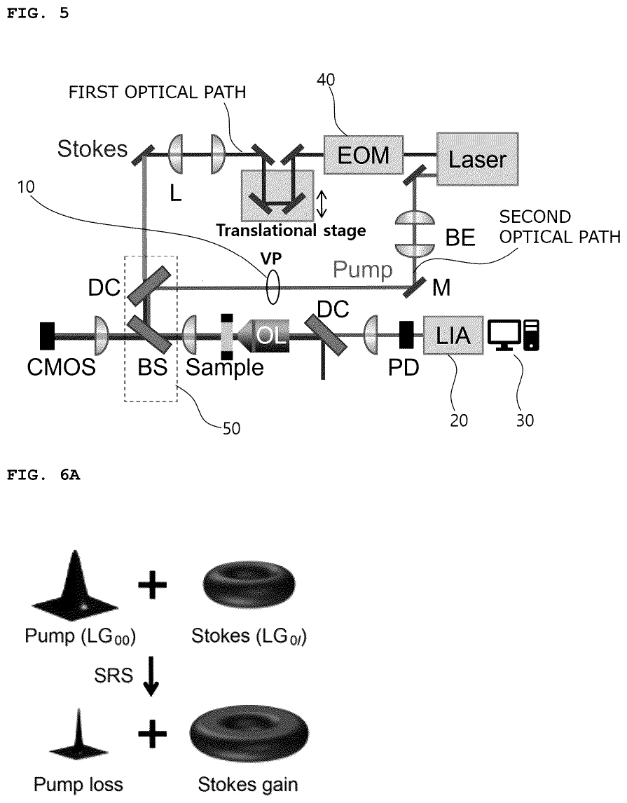

FIG. 4 is a configuration diagram of an apparatus for detecting an orbital angular momentum of light according to an embodiment of the present disclosure, and FIG. 5 is a configuration diagram of an apparatus for detecting an orbital angular momentum of light according to another embodiment of the present disclosure.

As illustrated in FIGS. 4 and 5, the apparatus for detecting an orbital angular momentum of light according to an embodiment of the present disclosure is an apparatus for detecting an orbital angular momentum of light using a stimulated Raman scattering (SRS) spectroscopy device, and includes vortex beam generating means 10 that, when one of a pump beam and a Stokes beam is a vortex beam to be detected and the other is an opposing beam, is disposed on an opposing beam path, which is not shared with the vortex beam to be detected and along which only the opposing beam moves and changes the topological charge of the opposing beam, a signal output unit 20 that generates an output signal for each topological charge of the opposing beam, and an QAM measurement unit 30 that measures an orbital angular momentum (OAM) of the vortex beam to be detected, based on the output signals generated by the signal output unit 20.

Since the aforementioned method for detecting an orbital angular momentum of light can use the nonlinear optical detection technique, that is, the stimulated Raman scattering (SRS) spectroscopy, the apparatus for detecting an orbital angular momentum of light according to an embodiment of the present disclosure can be implemented based on an SRS device.

In the SRS device, a pump beam and a Stokes beam are used, wherein one of the pump beam and the Stokes beam is a vortex beam to be detected and the other is an opposing beam.

Specifically, the apparatus for detecting an orbital angular momentum of light according to an embodiment of the present disclosure includes the vortex beam generation means 10, the signal output unit 20, and the OAM measurement unit 30.

The vortex beam generation means 10 is means for changing the topological charge of the opposing beam. For example, the vortex beam generation means 10 may include at least one selected from the group consisting of a vortex plate (or spiral phase plate), a spatial light modulator, a diffractive optical element, a metasurface, a photonic integrated circuit, a holographic grating, and a Q-plate. However, the vortex beam generating means 10 is not necessarily limited thereto, and may be any means as long as it can change the topological charge of the opposing beam.

The vortex beam generating means 10 may be disposed on the opposing beam path, which is not shared with the vortex beam to be detected and along which only the opposing beam moves. The Stokes beam moves along a first optical path, and the pump beam moves along a second optical path and then is incident on a Raman-active sample along the same third optical path. In an embodiment of the present disclosure, the pump beam may be a vortex beam to be detected and the Stokes beam may be an opposing beam. In such a case, the vortex beam generation means 10 may be disposed on the first optical path to change the topological charge of the Stokes beam (see FIG. 4). On the other hand, in another embodiment of the present disclosure, the pump beam may be an opposing beam and the Stokes beam may be a vortex beam to be detected. In such a case, the vortex beam generation means 10 may be disposed on the second optical path to change the topological charge of the pump beam (see FIG. 5).

The signal output unit 20 generates the output signal for each topological charge of the opposing beam each time the topological charge of the opposing beam is changed. Such a signal output unit 20 may include a lock-in amplifier (LIA). The lock-in amplifier can remove noise from a fine SRS signal, integrate and amplify the signal, and convert the amplified signal into a high-sensitivity signal.

The OAM measuring unit 30 measures the orbital angular momentum (OAM) of the vortex beam to be detected, based on the output signals generated by the signal output unit 20. The OAM measuring unit 30 can receive information on the topological charge of the opposing beam changed by the vortex beam generating means 10 and information on the output signal for each topological charge of the opposing beam. By receiving such information and treating the topological charge of the opposing beam having the highest signal value among the output signals as the topological charge of the vortex beam to be detected, the OAM measuring unit 30 can measure the OAM of the vortex beam to be detected.

The apparatus for detecting an orbital angular momentum of light according to an embodiment of the present disclosure may further include an electro-optical modulator 40 and an optical incident unit 50.

The electro-optical modulator (EOM) 40 is disposed on the first optical path along which the Stokes beam moves and modulates the frequency of the Stokes beam. For example, the frequency of the Stokes beam can be reduced from 70 to 90 MHz to 10 to 30 MHz. Such an electro-optical modulator 40 significantly improves the signal-to-noise ratio when a signal is amplified by a lock-in amplifier (LIA).

The optical incident unit 50 allows the Stokes beam moving along the first optical path and the pump beam moving along the second optical path to be simultaneously incident onto the Raman-active sample. Such an optical incident unit 50 may include a dichroic mirror (DM). The dichroic mirror is a filter-type optical mirror that reflects light in a specific wavelength range and transmits light in other wavelength ranges, and allows the Stokes beam moving along the first optical path and the pump beam moving along the second optical path to move along the same optical path. On the other hand, the pump beam and the Stokes beam passing through the dichroic mirror may be reflected by a beam splitter (BS) or only a part thereof having passed through the beam splitter (BS) may be incident onto the Raman-active sample. The Raman-active sample may be a polymer film, but is not necessarily limited thereto.

In addition, the apparatus for detecting an orbital angular momentum of light according to an embodiment of the present disclosure may include a pulsed laser that generates the pump beam and the Stokes beam. In addition, a translational stage may be disposed on the first optical path to precisely adjust a visual difference (time delay) between the Stokes beam and the pump beam. A lens L, a mirror M, and the like may be disposed on the first optical path and the second optical path to align the Stokes beam and the pump beam. In addition, a beam expander composed of two lenses may be disposed along the optical path to equalize the magnitudes of the pump beam and the Stokes beam. In addition, a CMOS camera may be disposed to confirm whether exact focusing is achieved through residual light in the Raman-active sample. An objective lens (OL) may be disposed to collect a laser beam having undergone stimulated Raman scattering after passing through the sample, and send the collected laser beam to a photodetector PD.

The present disclosure is described below in more detail through experimental examples.

### 1. OVERVIEW

This study proposes a method for detecting an orbital angular momentum (OAM) of a vortex beam by utilizing nonlinear optical measurements. Since the proposed OAM detection method is an all-optical method in which all processes are optically performed, no additional materials are required to modulate the amplitude or phase of light during measurement. The proposed OAM detection method is also a non-destructive method in which photons are not annihilated by a photodetector and are preserved. Accordingly, since OAM information included in a vortex beam can be stably measured as is, the proposed OAM detection method is useful for quantum detection or long-distance communication where weak signals are detected or signal loss may occur. Moreover, the proposed OAM detection method can amplify the vortex beam even without changing topological charge. Through an SRS process, a pump beam transfers energy to a vortex Stokes beam and increases the intensity of the target vortex beam. That is, the intensity of the vortex beam carrying optical information can be amplified.

This study is the first to apply nonlinear optical coherent Raman detection to analysis of OAM of light, and numerically analyzes and experimentally verifies an Raman-coupled wave equation for a Laguerre-Gaussian (LG) pump beam and a Stokes beam. The results have confirmed that the stimulated Raman loss (SRL) of the pump beam increases as the spatial overlap between the Gaussian pump beam and the Laguerre-Gaussian (LG) Stokes beam increases, thereby demonstrating the feasibility of OAM detection using nonlinear optics.

This study is expected to contribute to the future development of optical communication and optical sensing technologies.

### 2. THEORETICAL DESCRIPTION

### A. Coupled Wave Equations for Pump Beam and the Stokes Beam

A wave equation for an electric field Ē with nonlinear polarization P̅⁽³⁾ is as follows.

$${∇}^{2} E - \frac{{n}^{2}}{{c}^{2}} \frac{{\partial }^{2} E}{\partial {t}^{2}} = \frac{4 π}{{c}^{2}} \frac{{\partial }^{2} {P}^{( 3 )}}{\partial {t}^{2}} \qquad ( 1 )$$

In the wave equation above, n is a refractive index and c is the speed of light.

This study focuses on the stimulated Raman scattering (SRS) process within the paraxial approximation.

The electric field propagating in the z-direction is expressed as follows.

$${E}_{j} ( x , y , z ) = {ε}_{j} ( x , y , z ) {e}^{{ik}_{j} z - i {ω}_{j} t} \qquad ( 2 )$$

In the electric field above, j represents a pump field and a Stokes field.

The key point is to determine the spatial amplitudes εⱼ(x,y,z) of the pump beam and the Stokes beam and the intensity distributions

$$\frac{1}{2} {ε}_{0} cn {\vert {E}_{j} ( x , y , z ) \vert}^{2}$$

of light (ε0 is a vacuum permittivity and ω is an angular frequency). This is particularly important when an input beam profile is adjusted using a spiral phase plate, a holographic grating, a metamaterial, or a spatial light modulator. This study utilizes stimulated Raman scattering using a pump beam in a high frequency field and a Stokes beam in a low-frequency field.

By substituting Equation (2) above into Equation (1) above and applying the slowly varying envelope approximation (SVEA), is obtained

$$\frac{{\partial }^{2} {ε}_{j}}{\partial {z}^{2}} ≪ 2 {ik}_{j} \frac{\partial {ε}_{j}}{\partial z}$$

(kⱼ is a wavenumber), resulting in the following coupled wave equations.

$${∇}_{i}^{2} {ε}_{p} + 2 {ik}_{p} \frac{\partial {ε}_{p}}{\partial z} = - \frac{4 π {k}_{p}^{2}}{{n}_{p}^{2}} {χ}_{ℛ}^{( 3 ) *} {\vert {ε}_{𝒮} \vert}^{2} {ε}_{p} \qquad ( 3 )$$

$${∇}_{i}^{2} {ε}_{𝒮} + 2 {ik}_{𝒮} \frac{\partial {ε}_{𝒮}}{\partial z} = - \frac{4 π {k}_{𝒮}^{2}}{{n}_{𝒮}^{2}} {χ}_{ℛ}^{( 3 )} {\vert {ε}_{p} \vert}^{2} {ε}_{𝒮} \qquad ( 4 )$$

In the coupled wave equations above,

$${∇}_{t}^{2} ≡ \frac{{\partial }^{4}}{\partial {x}^{2}} + \frac{{\partial }^{4}}{\partial {y}^{2}} .$$

On the right side of the wave equation for the pump (Stokes) beam, the coefficient

$${χ}_{R}^{{( 3 )}^{*}} ( {χ}_{R}^{( 3 )} ) ,$$

is significant and

$${χ}_{R}^{( 3 )}$$

represents Raman susceptibility.

Since an imaginary part of

$${χ}_{R}^{( 3 )}$$

is negative, the intensity of the pump beam decreases and the intensity of the Stokes beam increases during the SRS process. That is, during the SRS process, the pump beam experiences a stimulated Raman loss (SRL), while the Stokes beam experiences a stimulated Raman gain (SRG). Since such coupling of the pump beam and the Stokes beam affects the amplitude, phase, and intensity distributions, one beam can be controlled to extract information on the characteristics of the other beam.

### B. Coupled Equations for Laguerre-Gaussian (LG) Mode Expansion

When the intensity distributions of the pump beam and the Stokes beam have cylindrical symmetry, the amplitudes of the beams can be generally expanded into a complete set of orthonormal LG modes in a cylindrical coordinate system.

Hereinafter, the topological charges of the pump beam and the Stokes beam are denoted as lₚ and lₛ, respectively.

In order to measure the OAM of light through the SRS process, a vortex beam with a topological charge l_{c} is regarded a Stokes beam (lₛ=l_{c}). Such a Stokes beam forms a Raman coupling with the pump beam. A carrier frequency ωₚ of the pump beam is determined by the frequency ωₛ of the Stokes beam and a Raman active mode frequency ω_{vib} of a material selected for OAM detection. That is, ωₚ=ωₛ+ω_{vib} is established.

The initial beam profile can be expressed as follows.

$${ε}_{P} ( r , ϕ , {z}_{0} ) = {P}_{0}^{{l}_{P}} ( {z}_{0} ) {U}_{0}^{{l}_{P}} ( r , ϕ , {z}_{0} ) \qquad ( 5 )$$

$${ε}_{S} ( r , ϕ , {z}_{0} ) = {S}_{0}^{{l}_{S}} ( {z}_{0} ) {V}_{0}^{{l}_{S}} ( r , ϕ , {z}_{0} ) \qquad ( 6 )$$

In the above, z₀ represents the z-position of a front surface of a Raman medium.

$${P}_{n}^{{l}_{P}} ( z ) , {S}_{n}^{{l}_{S}} ( z )$$

are z-dependent expansion coefficients associated with the Raman loss and the Raman gain, respectively.

In addition, U_{n,I}(r,φ,z), V_{n,I}(r,φ,z) represent the Laguerre-Gaussian (LGₙₗ) modes of the pump beam and the Stokes beam, respectively, where n is a radial mode index and l is a rotational mode index.

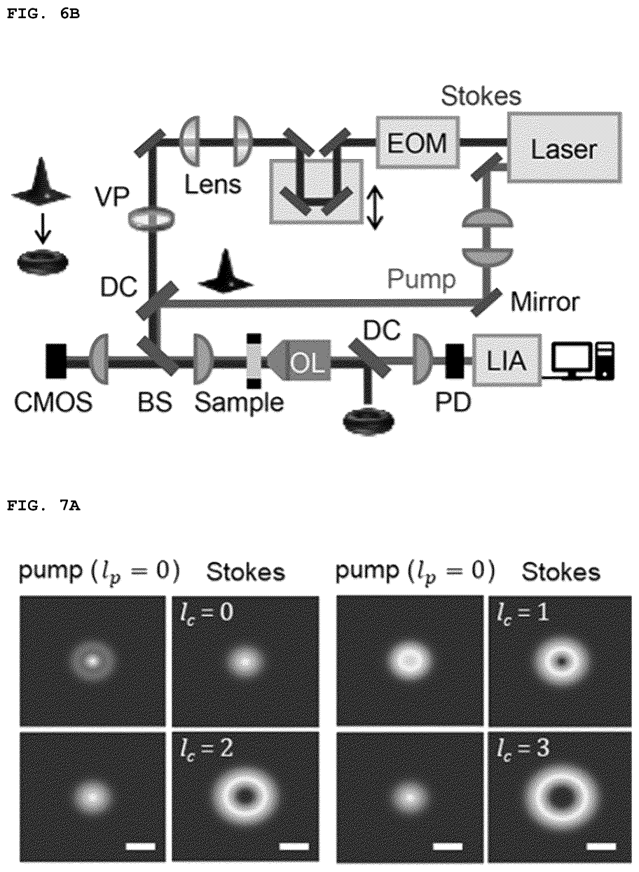

FIG. 6A is a diagram illustrating an SRS process of a Gaussian (LG₀₀) pump beam (1ₚ=0) and a doughnut-shaped (LG₀₁) Stokes beam (l≠0) according to an experimental example. After SRS, the intensity of the pump beam decreases (loss) and the intensity of the Stokes beam increases (gain), but the topological charge is preserved.

FIG. 6B is a schematic diagram schematically illustrating an SRS device (setup) according to the experimental example. The SRS device includes an electro-optical modulator EOM, a beam expander BE, a lens L, a mirror M, a vortex plate VP, a dichroic mirror DC, a beam splitter BS, a sample stage S, an objective lens OL, a lock-in amplifier LIA, and a photodetector PD. The stimulated Raman loss (SRL) is measured through the PD, and the OAM of the Stokes beam is non-destructively preserved.

### 3. RESULTS AND DISCUSSION

Using Equations (5) and (6) above as initial conditions, the coupled wave equations for the pump beam and the Stokes beam were numerically solved.

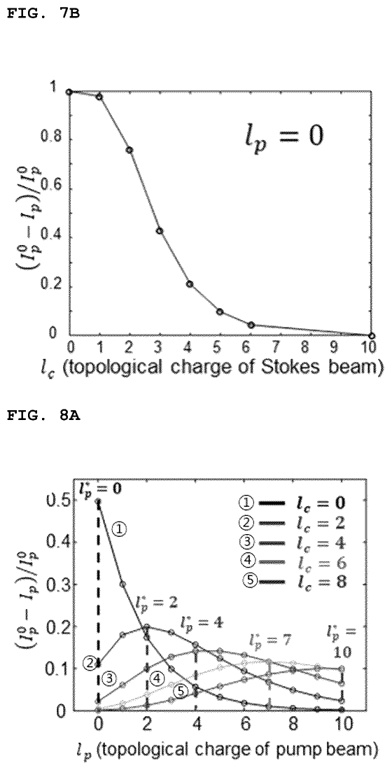

The wavelengths of the pump beam and the Stokes beam were set to 800 nm and 1000 nm, respectively, the Rayleigh ranges of the two beams were set to 3.7 μm and 4.62 μm, respectively, and the thickness of the Raman medium was set to 83.2 μm (i.e., L=41.6 μm). The Raman gain coefficient is 2.489×10⁻¹⁸ m/V². In the case of FIG. 7, the initial amplitudes of

$${P}_{0}^{00} ( {z}_{0} ) and {S}_{0}^{{l}_{0}} ( {z}_{0} )$$

and at z0 (=−L) are 0.752 MV, and in the case of FIG. 8(a), the initial amplitudes are 0.238 MV.

Based on the above parameters, the coupled wave equations for the pump beam and the Stokes beam were calculated using an finite difference method.

The lateral intensity distributions of the pump beam and vortex beam at the output plane z=L of the Raman medium are illustrated in FIG. 7. FIG. 7A illustrates the result obtained by numerically calculating the lateral intensity distributions of the pump beam (left column) and the vortex beam (right column) transmitted at z=L (=41.6 μm). It is assumed that the initial pump beam at z=−L is in an LG₀₀ mode (Gaussian) and the initial vortex beam is in an LG_{0ic} mode with I_{c}=0 to 3. The scale bar is 16.64 μm.

Due to the significant spatial overlap between the Gaussian pump beam and the LG_{OIc} vortex beam with a small topological charge l_{c}, the intensity of the transmitted pump beam experiences attenuation due to stimulated Raman loss (SRL), so that the intensity distribution thereof deviates from the initial Gaussian shape. On the other hand, the intensity of the transmitted Stokes beam increases when the topological charge increases, but the spatial distribution thereof remains unchanged (see FIG. 7A). The SRS process does not induce coupling between LG modes with different topological charges, but may induce mixing of LG modes with different radial indices. Such conservation of OAM of light can be understood by the fact that beams with different helices are not mixed because the isotropic Raman medium is centrosymmetric and achiral.

Accordingly, the SRS-based OAM detection method proposed in this study can non-destructively measure the OAM of light while preserving the OAM, and can amplify the vortex beam without changing the topological charge. In order to evaluate the degree of the SRL of the pump beam, the integrated intensity of the pump beam at the end of the Raman medium (z=L) was calculated and represented as Iₚ. In addition, the integrated intensity of a reference pump beam when the Stokes beam is not present as a vortex beam was represented as

$${I}_{P}^{0} .$$

The relative SRL of the intensity of the pump beam can be expressed as the ratio of

$$( {I}_{P}^{0} - {I}_{p} ) / {I}_{P}^{0} ,$$

and can be measured by modulating the vortex beam and using a lock-in amplifier. When the intensity of the incident Stokes vortex beam varies with the topological charge, the measured pump loss signal is normalized.

FIG. 7B illustrates the laterally integrated intensity Iₚ (z=L) of the vortex beam calculated at the topological charge 1_{c}=0 to 10 and

$$( {I}_{P}^{0} - {I}_{p} ) / {I}_{P}^{0}$$

versus 1_{c}, and illustrates that, for vortex beams with small 1_{c}, strong SRL of the LG₀₀ pump beam occurs by extensive SRS in an area where the pump beam and the Stokes beam spatially overlap in a wide range and thus an intensity ratio approaches 1. On the other hand, when the topological charge of the vortex beam increases, the beam overlap area decreases and the SRL of the pump beam is decreased, so that the intensity ratio converges to 0.

In order to determine the value of the topological charge I_{c} of the vortex beam, the SRL signal

$$( {I}_{P}^{0} - {I}_{p} ) / {I}_{P}^{0}$$

was measured while scanning the topological charge I_{P} of the pump beam. FIG. 8A illustrates the SRL of the pump beam for the topological charge 1ₚ of the pump beam when the topological charge I_{c} of the vortex beam is 0, 2, 4, 6, and 8 and the result

$$( {I}_{P}^{0} - {I}_{p} ) / {I}_{P}^{0}$$

versus the topological charge 1ₚ. When the I_{C} of the vortex beam carrying information is 0, 2, 4, 6, and 8, pump beams with different I_{P} values show different spatial overlaps, resulting in different SRL processes. The I_{P} value (denoted as l*_{P}) at the maximum value of

$$( {I}_{P}^{0} - {I}_{p} ) / {I}_{P}^{0}$$

is linearly correlated with I_{C} when I_{C} is smaller than 5. In the case of l_{c}≤4, l*_{P} coincides with l_{C}. However, in the case of l_{C}≥5, l*_{P} is slightly larger than l_{C} due to the wavelength difference between the pump beam and the Stokes beam.

The correlation between l*_{P} that is a measurable quantity and l_{C} of the vortex beam suggests that the OAM of light can be measured using a nonlinear optical detection apparatus.

In order to verify the numerical results above,

$$( {I}_{P}^{0} - {I}_{p} ) / {I}_{P}^{0}$$

was measured using the custom-built Raman device (FIG. 6B). The topological charge of the Stokes beam was adjusted using a vortex plate (VP) (l_{C}=0, 1, 2, 3). Polystyrene (PS) and polymethyl methacrylate (PMMA) films were used as the Raman-active material. For PS, intensities of the pump beams PS1 to PS3 were adjusted to 0.30, 0.27, and 0.21 mW/μm², respectively.

FIG. 8B is a graph comparing the numerically calculated value

$$( {I}_{P}^{0} - {I}_{p} ) / {I}_{P}^{0}$$

(red) with the experimentally derived value. FIG. 8B illustrates the SRL values of the pump beam to the l_{C} of the Stokes beam (OAM beam) after the SRS process. As a result, as expected, as the l_{C} of the Stokes beam increases, the SRL of the pump beam was decreased. This indicates that the spatial overlap between the Gaussian pump beam and the vortex beam decreases as the internal aperture of the vortex beam with a large l_{C} increases (see FIG. 7).

When the calculated results of SRL are compared with the experimental results, the experimental results were consistent with the theoretical calculation results despite a difference between the outputs PS1 to PS3 of the materials and the pump beam. Such results indicate that the OAM of the vortex beam can be stably measured using the nonlinear optical detection.

### 4. CONCLUSION

This study has presented a theoretical framework for a new method for detecting the orbital angular momentum (OAM) of light by using the stimulated Raman scattering (SRS) and verified the feasibility through the numerical calculations and experiments.

It was confirmed that the degree of the stimulated Raman loss (SRL) of the pump beam depends on the OAM magnitudes of both the pump beam and the vortex beam. Therefore, this method can be utilized to confirm the magnitude of vortex beams used in optical communications.

Although the present disclosure has been described in detail through specific embodiments and experimental examples, the embodiments are intended to describe the present disclosure in detail, the present disclosure is not limited thereto, and it is apparent that modifications or improvements thereof can be made within the technical scope of the invention by those skilled in the art.

All simple modifications and changes of the present disclosure fall within the scope of the present disclosure, and the specific scope of the present disclosure will be clarified by the appended claims.

What is claimed is:

1. A method for detecting an orbital angular momentum of light, the method comprising:
a step of, when one of two input laser beams is a vortex beam to be detected, obtaining an output signal for each topological charge (TC) of an opposing beam by using a nonlinear optical detection technique while changing the topological charge of the opposing beam, the opposing beam being the other one of the two input laser beams; and
a step of measuring an orbital angular momentum (OAM) of the vortex beam to be detected, based on the topological charge of the opposing beam having a highest signal value among the output signals.

2. The method of claim 1, wherein the nonlinear optical detection technique is any one selected from the group consisting of stimulated Raman scattering (SRS) spectroscopy, coherent anti-Stokes Raman scattering (CARS) spectroscopy, and sum-frequency generation (SFG) spectroscopy.

3. The method of claim 1, wherein the topological charge of the opposing beam is changed by vortex beam generation means disposed on an opposing beam path, the opposing beam path not being shared with the vortex beam to be detected, only the opposing beam moving along the opposing beam path.

4. The method of claim 3, wherein the vortex beam generation means includes at least one selected from the group consisting of a vortex plate (or spiral phase plate), a spatial light modulator, a diffractive optical element, a metasurface, a photonic integrated circuit, a holographic grating, and a Q-plate.

5. The method of claim 1, wherein a topological charge of the vortex beam to be detected corresponds to the topological charge of the opposing beam having the highest signal value among the output signals.

6. An apparatus for detecting an orbital angular momentum of light using a stimulated Raman scattering (SRS) spectroscopy device, the apparatus comprising:
vortex beam generating means that, when one of a pump beam and a Stokes beam is a vortex beam to be detected and the other is an opposing beam, is disposed on an opposing beam path, the opposing beam path not being shared with the vortex beam to be detected, only the opposing beam moving along the opposing beam path, and changes a topological charge of the opposing beam;
a signal output unit that generates an output signal for each topological charge of the opposing beam; and
an OAM measurement unit that measures an orbital angular momentum (OAM) of the vortex beam to be detected, based on the output signal generated by the signal output unit.

7. The apparatus of claim 6, further comprising:
an electro-optical modulator disposed on a first optical path along which the Stokes beam moves and configured to modulate a frequency of the Stokes beam; and
an optical incident unit configured to allow the Stokes beam moving along the first optical path and the pump beam moving along a second optical path to be simultaneously incident onto a Raman-active sample,
wherein the vortex beam generating means is disposed on the first optical path or the second optical path.

8. The apparatus of claim 6, wherein the vortex beam generation means includes at least one selected from the group consisting of a vortex plate (or spiral phase plate), a spatial light modulator, a diffractive optical element, a metasurface, a photonic integrated circuit, a holographic grating, and a Q-plate.

9. The apparatus of claim 6, wherein the OAM measuring unit treats the topological charge of the opposing beam having a highest signal value among the output signals as a topological charge of the vortex beam to be detected.
